(19) United States
(12) Patent Application Publication
(10) Pub. No.: US 2011/0146736 A1
(43) Pub. Date: Jun. 23, 2011

(54) Walker

(76) Inventor: Ellen S. Pfafflin, Allen Park, MI (US)

(21) Appl. No.: 12/960,629

(22) Filed: Dec. 6, 2010

Related U.S. Application Data
(60) Provisional application No. 61/289,071, filed on Dec. 22, 2009.

(51) Int. Cl. A61H 3/04; B60B 33/00

(52) U.S. Cl. 135/67; 16/45

(57) ABSTRACT

A walker has a wheel rotatably mounted to the lower end of each of a pair of front legs, each wheel having a series of end to end smaller diameter rollers mounted about the axis of wheels 10 define an outer perimeter of said wheels to allow easier turning of the walker without applying a lift force to the front legs while maintaining a tendency for the walker to track in a forward direction when a turning force is not applied.

### CROSS REFERENCE TO RELATED APPLICATIONS

This application claims the benefit of U.S. provisional application No. 61/289,071, filed on Dec. 22, 2009.

### BACKGROUND OF THE INVENTION

This application concerns walkers widely used to assist persons in walking if there is a risk of falling because of an injury, surgery or a debilitating illness or general feebleness produced as a result of advanced age.

Such walkers comprise a stable four legged framework having horizontal members which the person holds on to for support as he or she walks forward, advancing the walker by pushing on the horizontal members.

Typically, such walkers have wheels on the bottom of the front two legs to reduce resistance to pushing the walker forward, and rubber or other non-slip tips on the two rear legs to prevent the walker from having any tendency for uncontrolled forward rolling.

When turning, a user exerts a lifting force on the front end of the walker to reduce the friction of the wheels when attempting to drag them sideways, allowing it to be angled in the direction in which he or she wants to turn. Thus, during turning movements, the support the walker intended to provide the user is compromised by the need to exert a lifting force on the walker.

While pivoted casters have been used to aid turning a walker, casters have a tendency to easily turn and have less than straight ahead directional stability. This requires the user to diligently monitor the front legs from unintended wandering to either side.

It is an object of the present invention to provide a walker which does not require a lifting force to be exerted on a walker having wheels on the forward legs to execute a turn but which maintains tracking stability in a straight ahead direction.

### SUMMARY OF THE INVENTION

The above recited object of the invention and other objects which will become apparent upon a reading of the following specification and claims are achieved by a walker in which the front legs are supported by wheels which track forwardly in conventional fashion. According to the invention, the wheels also each have a series of small diameter rollers mounted about the periphery thereof which rollers freely rotate about a tangential axis. The rollers at the bottom of the wheels in contact with the floor allow friction free sideways movement of the wheels. This enables turning of the walker without the need to exert a lifting force on the front legs so that the walker continues to maintain support for the user when making a turn. At the same time, forward tracking stability is largely maintained since the rollers can only rotate at right angles to the forward direction and thus any tendency to drift away from the forward direction is avoided as often happens with pivoted casters

### DESCRIPTION OF THE DRAWINGS

FIG. 1 is a pictorial view of a walker according to the present invention in use by a person.

FIG. 2 is an enlarged pictorial view of the bottom portion of a front leg of the walker shown in FIG. 1 showing the details of one of the front leg mounted wheels.

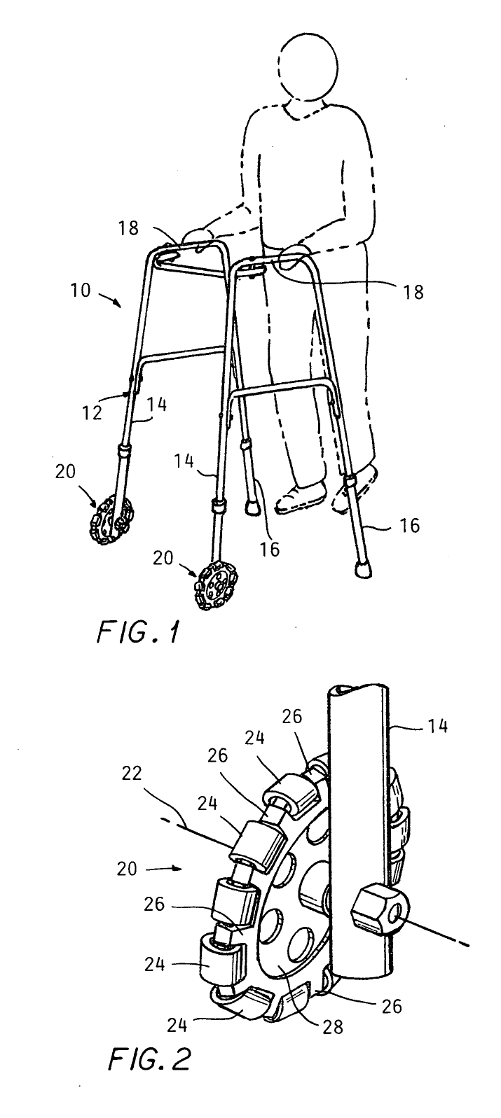

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings, a walker 10 according to the invention is shown which comprises a conventional framework 12, including two slightly forward angled front legs 14 and two slightly rearwardly angled rear legs 16, the legs supporting cross members 18 fixed thereto at the top positioned at a height conveniently graspable by the user. The legs 14, 16 may be made from tubular metal such as aluminum or steel and of a telescoping construction in the well known manner to allow length adjustments to be suited to the height of a particular user. The four angled legs 14, 16 of the framework 12 resting on the floor renders the walker 10 quite stable against tipping to allow a person moving forwardly while holding onto the cross members 18 to securely maintain his or her balance in the well known manner.

The lower end of each of the front legs 14 has a wheel 20 mounted on the outside thereof for free rotation about a horizontal axis 22 extending sideways to the walker 10 so that the walker 10 will normally tend to track straight ahead as it is advanced ahead in a forward direction by the user.

The rolling of the wheels 20 allow the walker 10 to be easily moved forward when the user walks straight ahead while maintaining a straight ahead tracking motion of the walker 10, not requiring the user to constantly exert any efforts to restrain the walker 10 from turning as would be necessary with casters.

According to the present invention, the wheels 20 are of a special design which have been used in other devices, in which a series of smaller diameter preferably barrel shaped plastic rollers 24 are arranged extending around the perimeter of each of the wheels 20. The wheels 20 are of a diameter on the order of several inches while the rollers 24 each have a much smaller diameter on the order of around one inch. This proportion makes the wheels 20 easier to turn than the smaller diameter roller 24. The rollers 24 are of equal diameter and are generally mounted end-to-end to each other but at a slight angle to define the curvature of the wheel perimeter. The rollers 24 can be mounted between radial projections 26 formed about the hub 28 of each wheel 20 for rotation about a tangential axis. The rollers 24 are preferably barrel shaped with the outer sides thereby more nearly defining a circular perimeter of a respective wheel 20.

By applying only a slight turning force on the walker 10, the rollers 24 in contact with the floor readily enable a sideways movement at angles to the front legs 14 without the need to exert a lifting force on the front legs 14. This sideways rolling of the rollers 24 in contact with the floor allows the user to easily turn the walker 10 at some angle to the straight ahead direction.

Since the rollers 24 only revolve when the user exerts a turning force on the walker to cause the legs 14 to be moved at some angle to the wheels 20, there is much less tendency to spontaneously wander to the side and to normally track straight ahead.

At the same time, the rollers 24 can more easily rotate upon exertion of a sideways force than the sideways dragging of the wheels necessary in a conventional wheeled walker. Thus, the walker 10 is stable when moving straight ahead but can be easily turned at any angle without applying a lifting force to the front legs.

Accordingly, the walker 10 provides a secure, stable support for the user even while being turned.

1. A walker comprising:
a framework including two front legs and two rear legs, said legs connected together at upper portions thereof with generally horizontal easily graspable members;
a wheel mounted at a lower end of each of said forward legs for rotation about a horizontal axis when said walker is propelled in a forward direction, each of said wheels having a series of rollers mounted approximately end to end extending around an axis of each wheel to define an outer perimeter of said respective wheels, each roller mounted for rolling movement about an axis extending in a tangential direction with respect to a respective wheel axis and substantially at a right angle to said forward direction whereby said walker is easily turned at an angle to a straight ahead direction by rolling of said rollers in contact with the surface on which said walker is supported but tends to track in a straight ahead direction when turning forces are not applied to said walker.

2. The walker according to claim 1 wherein said wheels are of an equal diameter which is several times the diameter of said rollers
